(19) United States
(12) Patent Application Publication
(10) Pub. No.: US 2015/0132194 A1
(43) Pub. Date: May 14, 2015

(54) SYSTEM FOR LOW-CONCENTRATION-METHANE GAS OXIDATION EQUIPPED WITH MULTIPLE OXIDIZERS

(71) Applicant: KAWASAKI JUKOGYO KABUSHIKI KAISHA, Kobe-shi (JP)

(72) Inventors: Shinichi KAJITA, Kobe-shi (JP); Yoshihiro YAMASAKI, Kobe-shi (JP)

(73) Assignee: KAWASAKI JUKOGYO KABUSHIKI KAISHA, Kobe-shi (JP)

(21) Appl. No.: 14/605,346

(22) Filed: Jan. 26, 2015

Related U.S. Application Data
(63) Continuation of application No. PCT/JP2013/066647, filed on Jun. 18, 2013.

(30) Foreign Application Priority Data
Jul. 27, 2012 (JP) 2012-166616

(51) Int. Cl. B01D 53/86; F02C 6/18

(52) U.S. Cl. CPC B01D 53/864; F02C 6/18
USPC 422/173

(57) ABSTRACT

A low-concentration methane gas oxidation system includes: a single heat source device; and an oxidation device to oxidize low-concentration methane gas by using heat from the heat source device. The oxidation device includes a plurality of individual oxidation units including respective catalyst oxidizers. The individual oxidation units include: a first individual oxidation unit including a first catalyst oxidizer using heat of heat source gas from the heat source device, and a first heat exchanger to preheat low-concentration methane gas that flows into an additional catalyst oxidizer provided in a branching supply passage on downstream side, by using, as a heating medium, oxidized gas from the first catalyst oxidizer; and at least one additional individual oxidation unit including an additional catalyst oxidizer to oxidize low-concentration methane gas preheated by the first catalyst oxidizer or the additional catalyst oxidizer provided in a branching supply passage on upstream side.

### CROSS REFERENCE TO THE RELATED APPLICATION

This application is a continuation application, under 35 U.S.C. §111(a), of international application No. PCT/JP2013/066647, filed Jun. 18, 2013, which claims priority to Japanese patent application No. 2012-166616, filed Jul. 27, 2012, the disclosure of which are incorporated by reference in their entirety into this application.

### BACKGROUND OF THE INVENTION

1. Field of the Invention

The present invention relates to a system which oxidizes a low-concentration methane gas such as VAM (Ventilation Air Methane) generated from a coal mine.

2. Description of Related Art

In order to reduce greenhouse effect gases, it is necessary to oxidize a low-concentration methane gas such as VAM discharged from a coal mine to the atmosphere. As such an oxidation apparatus, hitherto, a system is known in which VAM is oxidized by catalytic combustion using waste heat from an external heat source device (e.g., Patent Document 1). In the example of Patent

Document 1, a low-concentration methane gas is heated to a catalytic reaction temperature by using waste heat from a lean fuel gas turbine engine. Thereafter, the low-concentration methane gas is caused to flow to a catalyst layer, and is burned there.

### PATENT DOCUMENT

[Patent Document 1] Japanese Patent No. 4538077

### SUMMARY OF THE INVENTION

In the oxidation system disclosed in Patent Document 1, only one catalyst oxidation apparatus can be combined with one gas turbine engine. Therefore, when the discharge amount of VAM to be treated is enormous, it is necessary to provide a plurality of oxidation systems each including a gas turbine engine and a catalyst oxidation apparatus. However, it is sometimes difficult to provide a plurality of such systems in terms of installation space and cost. As a result, sufficient VAM treatment performance cannot be achieved.

In order to solve the above problem, an object of the present invention is to provide a low-concentration methane gas oxidation system in which a plurality of catalyst oxidizers are combined with a single heat source device, thereby to treat an enormous amount of low-concentration methane gas at a low cost while suppressing an increase in a space where the system is installed.

In order to achieve the above-described object, a low-concentration methane gas oxidation system according to the present invention includes: a single heat source device; and an oxidation device to catalytically oxidize a low-concentration methane gas by using heat from the single heat source device, in which the oxidation device includes a plurality of branching supply passages which branch, in parallel, from a main low-concentration gas supply passage to supply the low-concentration methane gas, and a plurality of individual oxidation units, the individual oxidation units including respective catalyst oxidizers provided in the respective branching supply passages. The individual oxidation units include: a first individual oxidation unit including a first catalyst oxidizer to perform catalytic oxidation by using heat of a heat source gas from the heat source device, and a first heat exchanger to preheat the low-concentration methane gas that flows into an additional catalyst oxidizer provided in a branching supply passage on a downstream side, by using, as a heating medium, an oxidized gas discharged from the first catalyst oxidizer; and at least one additional individual oxidation unit including an additional catalyst oxidizer to catalytically oxidize a low-concentration methane gas preheated by a first catalyst oxidizer or an additional catalyst oxidizer provided in a branching supply passage on an upstream side, and an additional heat exchanger which uses, as a heating medium, an oxidized gas discharged from the additional catalyst oxidizer. The heat source device is, for example, a lean fuel intake gas turbine which uses, as a fuel, a combustible component contained in the low-concentration methane gas.

According to the above configuration, the plurality of catalyst oxidizers can be combined with the single heat source device. As a result, it is possible to treat an enormous amount of low-concentration methane gas at a low cost while suppressing an increase in the space where the system is installed.

In one embodiment of the present invention, preferably, each of the at least one additional individual oxidation unit may include an additional heat exchanger to preheat a low-concentration methane gas that flows into another additional catalyst oxidizer provided in a branching supply passage on a downstream side or into the first catalyst oxidizer, by using, as a heating medium, an oxidized gas discharged from the additional catalyst oxidizer in the additional individual oxidation unit. According to this configuration, in each individual oxidation unit, the low-concentration methane gas can be preheated by using waste heat from another individual oxidation unit. Thus, the efficiency of the entire system can be enhanced.

In one embodiment of the present invention, each of the first individual oxidation unit and the at least one additional individual oxidation unit may include a bottom duct forming a passage for the oxidized gas from the catalyst oxidizer to the heat exchanger in each catalyst oxidation unit. The bottom duct may have a side portion connected with the catalyst oxidizer and may also have an upper portion connected with the heat exchanger. According to this configuration, it is possible to simply and compactly configure the system by connecting the plurality of individual oxidation units one behind another in the same direction. Further, it is possible to easily increase and decrease the catalyst oxidation performance in accordance with the required amount of low-concentration methane gas to be treated.

In one embodiment of the present invention, the heat exchanger in each catalyst oxidation unit may include a heating medium passage to allow the oxidized gas as a heating medium to pass therethrough in a direction vertically upward from the bottom duct.

Any combination of at least two constructions, disclosed in the appended claims and/or the specification and/or the accompanying drawings should be construed as included within the scope of the present invention. In particular, any combination of two or more of the appended claims should be equally construed as included within the scope of the present invention.

### BRIEF DESCRIPTION OF THE DRAWINGS

In any event, the present invention will become more clearly understood from the following description of embodiments thereof, when taken in conjunction with the accompanying drawings. However, the embodiments and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a block diagram showing a schematic configuration of a low-concentration methane gas oxidation system according to an embodiment of the present invention;

FIG. 2 is a plan view showing the structure of the low-concentration methane gas oxidation system shown in FIG. 1;

FIG. 3A is a plan view showing a portion of the low-concentration methane gas oxidation system shown in FIG. 2;

FIG. 3B is a side view showing a portion of the low-concentration methane gas oxidation system shown in FIG. 2;

FIG. 4 is a block diagram showing a schematic configuration of a low-concentration methane gas oxidation system according to a modification of the embodiment shown in FIG. 1; and

FIG. 5 is a block diagram showing a schematic configuration of a low-concentration methane gas oxidation system according to another modification of the embodiment shown in FIG. 1.

### DESCRIPTION OF EMBODIMENTS

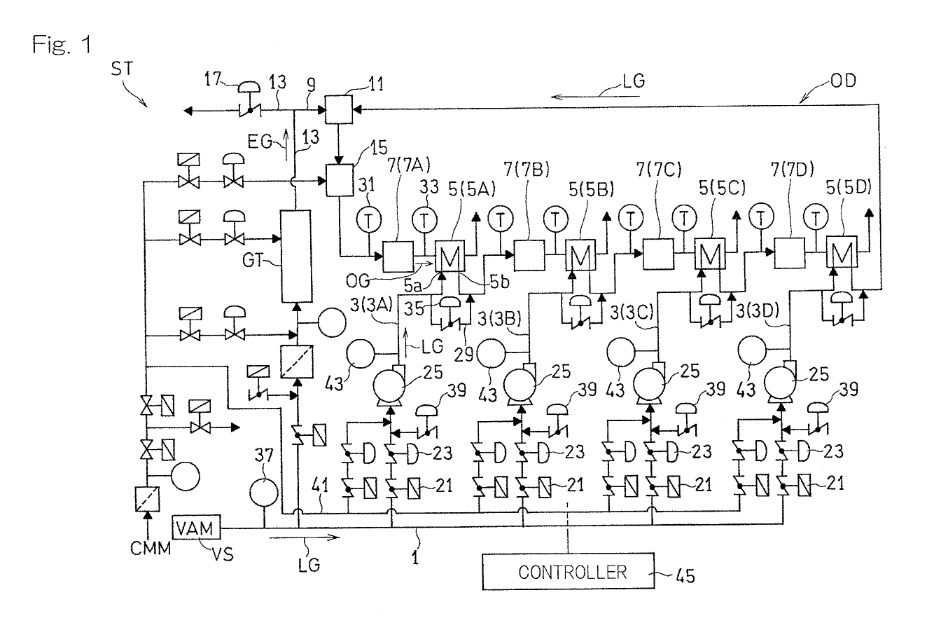

Hereinafter, embodiments of the present invention will be described with reference to the drawings. FIG. 1 is a schematic configuration diagram showing a low-concentration methane gas oxidation system (hereinafter, referred to simply as “oxidation system”) ST according to one embodiment of the present invention. The oxidation system ST oxidizes a low-concentration methane gas LG such as VAM discharged from a coal mine, at a low-concentration methane gas oxidation device OD by using waste heat from a gas turbine engine GT which is a heat source device.

In the present embodiment, a lean fuel intake gas turbine may be used as the gas turbine engine GT. The lean fuel intake gas turbine uses, as a fuel, a combustible component contained in a low-concentration methane gas LG which is an oxidation treatment target of the oxidation system ST. As the low-concentration methane gas LG used in the gas turbine engine GT, for example, VAM generated from a coal mine is used. To the methane gas oxidation device OD and the gas turbine engine GT, VAM as the low-concentration methane gas LG is supplied from a shared VAM supply source VS. The gas turbine engine GT of the present embodiment uses, as a fuel, in addition to VAM, CMM (Coal Mine Methane) which is a low-concentration methane gas whose methane concentration is higher than that of VAM.

In the low-concentration methane gas oxidation device OD, the low-concentration methane gas LG as an oxidation treatment target is supplied from a low-concentration methane gas supply source (VAM supply source) VS, and passes through a main low-concentration gas supply passage 1 and a plurality of (four in the illustrated example) branching low-concentration gas supply passages 3 which branch in parallel from the main low-concentration gas supply passage 1. Then, the low-concentration methane gas LG is preheated by heat exchangers 5 each provided in each branching low-concentration gas supply passage 3, and thereafter, is catalytically oxidized by catalyst oxidizers 7 provided at the downstream side of the heat exchangers 5. Each heat exchanger 5 uses, as a heating medium, a turbine exhaust gas EG supplied from the gas turbine engine GT via a heating medium supply passage 9 or a high-temperature oxidized gas OG discharged from an adjacent upstream-side catalyst oxidizer 7. The oxidized gas OG, as a heating medium, passes through the heat exchanger 5, and thereafter, is discharged to the outside.

In the present embodiment, only one catalyst oxidizer 7 among the plurality of catalyst oxidizers 7 directly uses a heat of the high-temperature turbine exhaust gas EG which is a heat source gas from the gas turbine engine GT which is a heat source device. In the illustrated example, the turbine exhaust gas EG from the gas turbine engine GT flows into the catalyst oxidizer 7 as a heating medium. In the following example, among the plurality of catalyst oxidizers 7, the catalyst oxidizer 7 to which the turbine exhaust gas EG from the gas turbine engine GT is directly introduced is referred to as a first catalyst oxidizer 7A, according to need. An adjacent heat exchanger 5 which uses, as a heating medium, the oxidized gas OG discharged from the first catalyst oxidizer 7A is referred to as a first heat exchanger 5A, and a branching low-concentration gas supply passage 3 which supplies the low-concentration methane gas LG as a medium to be heated to the first heat exchanger 5A is referred to as a first branching low-concentration gas supply passage 3A. An additional catalyst oxidizer 7 which oxidizes the low-concentration methane gas LG preheated in the first heat exchanger 5A (i.e., a catalyst oxidizer 7 provided in a second branching low-concentration gas supply passage 3B which branches from the downstream side of the first branching low-concentration gas supply passage 3A with respect to the main low-concentration gas supply passage 1) may be referred to as a second catalyst oxidizer 7B. Similarly, subsequent additional catalyst oxidizers, heat exchangers, and branching low-concentration gas supply passages may be referred to as third and fourth catalyst oxidizers 7C and 7D, second to fourth heat exchangers 5B to 5D, and second to fourth branching low-concentration gas supply passages 3B to 3D, respectively. In the present embodiment, the low-concentration methane gas LG heated in the fourth heat exchanger 5D is mixed with the turbine exhaust gas EG in a mixer 11 provided in the heating medium supply passage 9, is oxidized in the first catalyst oxidizer 7A, then passes through the first heat exchanger 5A as a heating medium, and thereafter, is discharged to the outside.

As described above, the low-concentration methane gas LG treated in each catalyst oxidizer 7 is preheated by using waste heat from the gas turbine engine GT or another catalyst oxidizer 7, whereby the efficiency of the entire system can be enhanced.

The heating medium supply passage 9 is provided so as to branch from an exhaust gas discharge passage 13 which discharges the turbine exhaust gas EG from the gas turbine engine GT to the outside. In the heating medium supply passage 9, a preheating burner 15 may be provided at the downstream side of the mixer 11. The preheating burner 15 is used to preheat a gas supplied to the first heat exchanger 5A when the oxidation system ST is started up. After the temperature of the gaseous mixture composed of the turbine exhaust gas EG and the low-concentration methane gas LG from the fourth heat exchanger 5D exceeds a predetermined value, preheating by the preheating burner 15 is stopped. In the illustrated example, CMM may be used as a fuel for the preheating burner 15. In the exhaust gas discharge passage 13, an exhaust gas amount regulating valve 17 which regulates the discharge amount of the exhaust gas is provided at the downstream side of a branch point from which the heating medium supply passage 9 branches.

A low-concentration gas on-off valve 21, which starts and stops introduction of the low-concentration methane gas LG, and a low-concentration gas flow rate regulating valve 23, which controls the flow rate of the low-concentration methane gas LG, are provided in this order at the downstream side of a branch point from which each branching supply passage 3 branches from the main low-concentration gas supply passage 1. A blower 25 which sends the low-concentration methane gas LG to the heat exchanger 5 is provided at the downstream side of the low-concentration gas flow rate regulating valve 23, and the downstream side of the blower 25 is connected to a medium-to-be-heated inlet 5a of the heat exchanger 5.

An inlet side passage and an outlet side passage for the low-concentration methane gas LG as a medium to be heated by the heat exchanger 5 are connected to each other through a heat exchanger bypass 29 which bypasses the low-concentration methane gas LG from the heat exchanger 5. In a heating medium inlet side passage, a first temperature measurement instrument 31 which measures the temperature of the heating medium flowing into the catalyst oxidizer 7 and a second temperature measurement instrument 33 which measures the temperature of the heating medium flowing out of the catalyst oxidizer 7 are provided. In the middle of the heat exchanger bypass 29, a bypass amount control valve 35 which controls the flow rate of the bypassed low-concentration methane gas LG is provided. When the temperature measured by the second temperature measurement instrument 33 exceeds a predetermined value, the opening degree of the bypass amount control valve 35 is adjusted to increase the flow rate of the low-concentration methane gas LG flowing through the heat exchanger bypass 29. Thereby, the temperature of the heating medium is decreased at the inlet of the catalyst oxidizer 7, and thus the catalyst in the catalyst oxidizer 7 is prevented from being excessively heated.

A first methane concentration sensor 37 is provided at the downstream side of the VAM supply source VS in the main low-concentration gas supply passage 1. In addition, each branching supply passage 3 has a portion at the downstream side of the low-concentration gas flow rate regulating valve 23 provided with an intake damper 39 for introducing outside air, also connected with a CMM supply passage 41 for supplying CMM that is a low-concentration methane gas whose concentration is higher than that of VAM is connected. When the methane concentration of the low-concentration methane gas LG measured by the first methane concentration sensor 37 exceeds a predetermined value, the intake damper 39 is opened to introduce air into the branching supply passage 3, thereby lowering the methane concentration. On the other hand, when the methane concentration of the low-concentration methane gas LG measured by the first methane concentration sensor 37 is lower than the predetermined value, CMM is introduced from the CMM supply passage 41 into the branching supply passage 3, thereby increasing the methane concentration. The methane concentration having been adjusted as described above is measured by a second methane concentration sensor 43 connected at the downstream side of the blower 25. A controller 45 controls the regulating valves, the on-off valves, and the like, based on the measurement values of the measurement instruments such as the temperature measurement instruments 31 and 33, the methane concentration sensors 37 and 43, and the like.

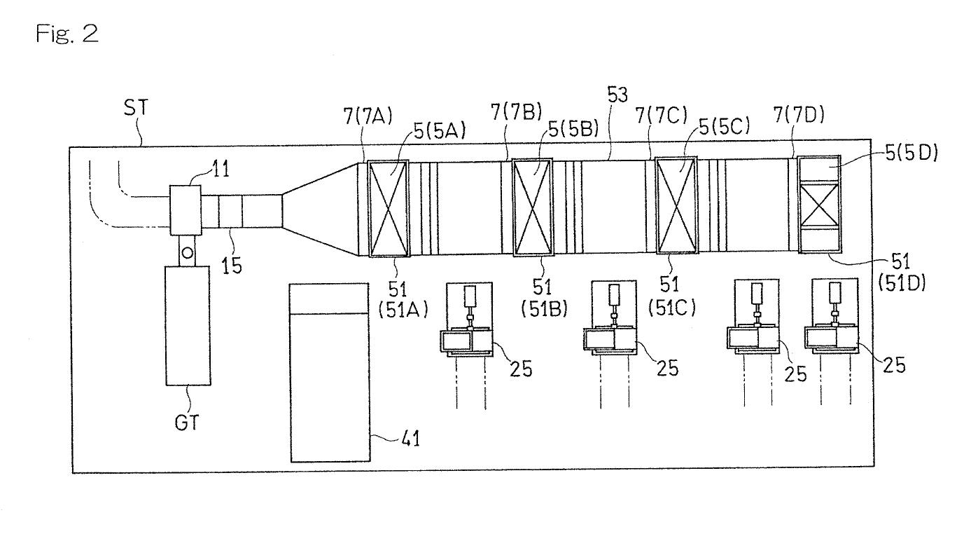

Next, the structure of the oxidation system ST will be described. As shown in FIG. 2, the oxidation system ST is structured as follows. That is, a plurality of (four in the present embodiment) individual oxidation units 51, each including one catalyst oxidizer 7 and one heat exchanger 5, are connected one behind another to provide an oxidation device main body 53, and peripheral equipments such as the blowers 25, the mixer 11, the gas turbine engine GT, and the like are connected to the oxidation device main body 53. The respective individual oxidation units 51, in order from one located closest to the gas turbine engine GT, include: a first catalyst oxidizer 7A and a first heat exchanger 5A; a second catalyst oxidizer 7B and a second heat exchanger 5B; a third catalyst oxidizer 7C and a third heat exchanger 5C; and a fourth catalyst oxidizer 7D and a fourth heat exchanger 5D. In the following description, the individual oxidation unit 51 that is located closest to the gas turbine engine GT and includes the first catalyst oxidizer 7A and the first heat exchanger 5A may be referred to as a first individual oxidation unit 51A, and the other additional individual oxidation units, in order from one adjacent to the first individual oxidation unit 51A, may be referred to as second individual oxidation unit 51B to a fourth individual oxidation unit 51D.

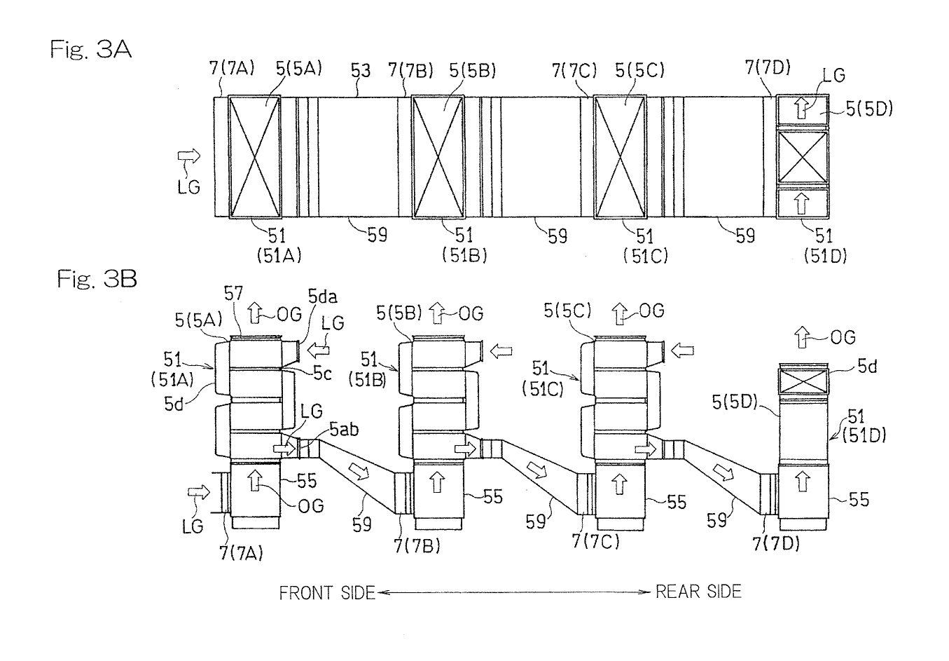

The structure of the oxidation device main body 53 will be described in detail with reference to FIGS. 3A and 3B. As shown in FIG. 3B, each of the individual oxidation units 51 forming the oxidation device main body 53 includes: a bottom duct 55 which forms an oxidized gas passage from the catalyst oxidizer 7 to the heat exchanger 5; a catalyst oxidizer 7 which is connected to and supported by a side portion of the bottom duct 55; and a heat exchanger 5 which is connected to and supported by an upper portion of the bottom duct 55. More specifically, the catalyst oxidizer 7 is mounted to one of two side portions, of the bottom duct 55, in the direction in which the individual oxidation units 51 are arranged in the oxidation device main body 53. In the following description, in the direction in which the individual oxidation units 51 are arranged in the oxidation device main body 53, the one side to which the catalyst oxidizer is mounted is referred to as “front side” and the other side opposite to the front side is referred to as “rear side”.

The heat exchanger 5 has a heating medium passage 5c which allows the oxidized gas OG as a heating medium to pass therethrough in a direction vertically upward from the bottom duct 55 side. In each of the first to third individual oxidation units 51A to 51C, a medium-to-be-heated passage 5d of the heat exchanger 5 has an inlet port 5da at the rear side of an upper portion of the heating medium passage 5c and an outlet port 5db at the rear side of a lower portion thereof, and is bent in a zigzag manner so as to cross the inside of the heating medium passage 5c in multiple times (four times in the illustrated example) in the front-rear direction, from the inlet port 5da to the outlet port 5db. When the oxidized gas OG as a heating medium passes through the inside of the heating medium passage 5c, the oxidized gas OG heats the low-concentration methane gas LG via the medium-to-be-heated passage 5d formed as described above, and thereafter, is discharged to the outside from an exhaust port 57 provided at an upper end of the heat exchanger 5.

The outlet port 5db of the medium-to-be-heated passage 5d of the heat exchanger 5 is connected to the catalyst oxidizer 7 of the adjacent individual oxidation unit 51, which catalyst oxidizer 7 is located obliquely downward to the rear side, by a connection duct 59 which forms a medium-to-be-heated outlet passage. Thus, the plurality of individual oxidation units 51 arranged one behind another are connected to each other such that the medium-to-be-heated passage outlet port 5db of the front-side individual oxidation unit 51 is connected with the rear-side catalyst oxidizer 7 by using the connection duct 59.

The fourth individual oxidation unit 51D located at the rear end is different in the structure of the heat exchanger 5 from the other individual oxidation units 51A to 51C. In the fourth individual oxidation unit 51D, the medium-to-be-heated passage 5d is provided in an upper portion of the heat exchanger 5 in the front-rear direction and a direction orthogonal to the vertical direction. The low-concentration methane gas LG heated in the fourth heat exchanger 5D is sent through a not-illustrated gas passage to the forward mixer 11 shown in FIG. 2.

As described above, according to the low-concentration methane gas oxidation system ST of the present embodiment, since the plurality of catalyst oxidizers 7 can be started up by using the heat from the single heat source device, it is possible to treat an enormous amount of low-concentration methane gas at a low cost. Further, it is possible to suppress an increase in the installation space of the entire system while greatly enhancing treatment capacity of the system.

In particular, the low-concentration methane gas LG supplied from each branching low-concentration gas supply passage 3 is used as a medium to be heated and the high-temperature oxidized gas OG obtained after the low-concentration methane gas LG supplied from the adjacent branching low-concentration gas supply passage 3 has been oxidized is used as a heating medium, and the low-concentration methane gas LG is preheated successively in the heat exchangers 5. Therefore, the oxidation device main body 53 can be made to have a simple and small structure in which a plurality of the individual oxidation units 5 leach including the catalyst oxidizer 7, the bottom duct 55, and the heat exchanger 5 are connected one behind another in the same direction. Thus, it is possible to achieve a reduction in the installation space of the oxidation system ST. In addition, it is possible to easily increase and decrease treatment capacity of the oxidation system ST (i.e., the number of the additional individual oxidation units 51 installed) corresponding to the required amount of the low-concentration methane gas LG to be treated.

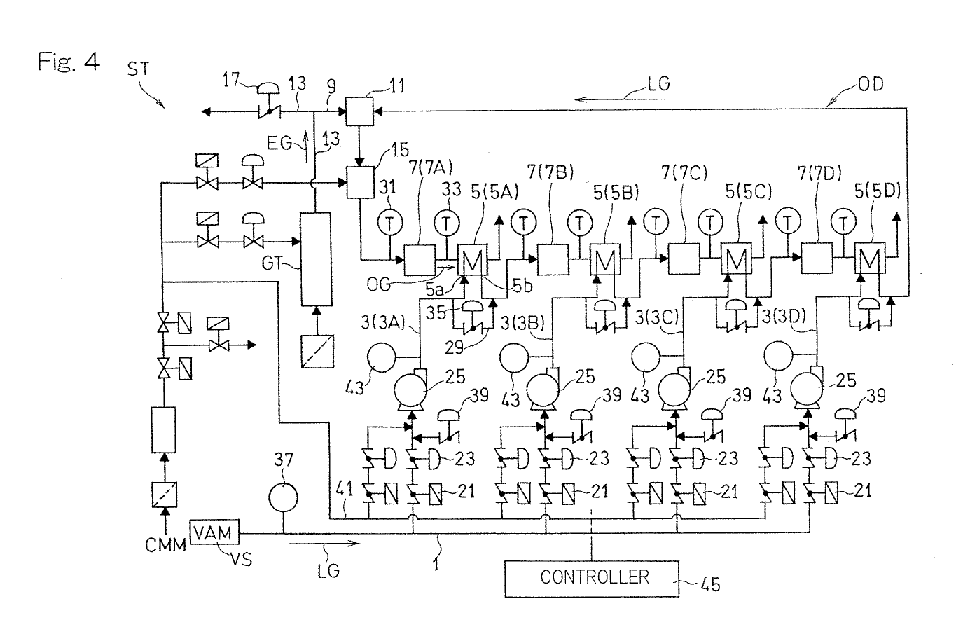

In a modification of the present embodiment, as the gas turbine engine GT which is a heat source device, instead of the lean fuel intake gas turbine which uses VAM as a working gas, an ordinary gas turbine engine as shown in FIG. 4 may be used which is not supplied with a fuel from the VAM supply source VS but is supplied with a fuel from the outside and uses air as a working gas. The heat source device is not limited to the gas turbine engine GT, and any device, such as a boiler, may be used as long as the device is capable of supplying a high-temperature gas without using VAM.

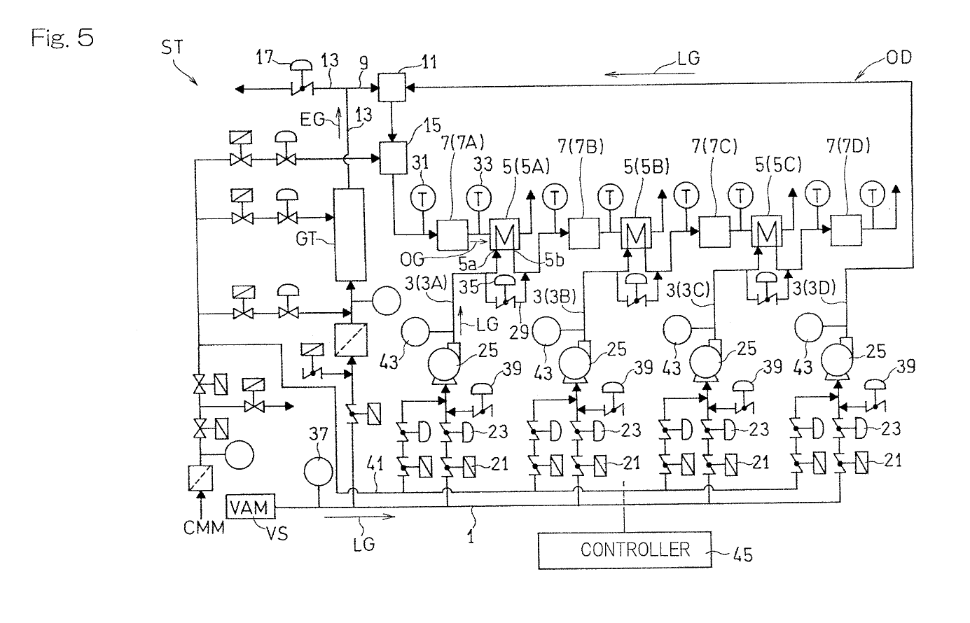

FIG. 5 shows another modification of the present embodiment. In the embodiment shown in FIG. 1, the fourth heat exchanger 5D is provided which preheats the low-concentration methane gas LG to be oxidized in the first catalyst oxidizer 7A, by using the heat of the oxidized gas OG treated in the fourth catalyst oxidizer 7D. In the example shown in FIG. 5, however, the fourth heat exchanger 5D is omitted, and the low-concentration methane gas LG to be oxidized in the first catalyst oxidizer 7A is directly introduced into the mixer 11 and mixed with the turbine exhaust gas EG

While in the above-described embodiment, the turbine exhaust gas EG from the gas turbine engine GT as a heat source device is introduced into the catalyst oxidizer 7 together with the low-concentration methane gas LG, and thus the heat of the turbine exhaust gas EG is used for the oxidation process. However, for example, the low-concentration methane gas LG to be introduced into the first catalyst oxidizer 7A may be preheated by the turbine exhaust gas EG via an additionally provided heat exchanger, thereby to use, for the oxidation process, the heat of the turbine exhaust gas EG.

Although the present invention has been described above in connection with the embodiments thereof with reference to the accompanying drawings, numerous additions, changes, or deletions can be made without departing from the gist of the present invention. Accordingly, such additions, changes, or deletions are to be construed as included in the scope of the present invention.

### REFERENCE NUMERALS

1 Main low-concentration gas supply passage

3 Branching low-concentration gas supply passage (Branching supply passage)

5 Heat exchanger

7 Catalyst oxidizer

51 Individual oxidation unit

EG Turbine exhaust gas

GT Gas turbine engine (heat source device)

LG Low-concentration methane gas

OG Oxidized gas

ST Low-concentration methane gas oxidation system

What is claimed is:

1. A low-concentration methane gas oxidation system, comprising:
a single heat source device; and
an oxidation device to catalytically oxidize a low-concentration methane gas by using heat from the single heat source device, wherein
the oxidation device includes a plurality of branching supply passages which branch, in parallel, from a main low-concentration gas supply passage to supply the low-concentration methane gas, and a plurality of individual oxidation units, the individual oxidation units including respective catalyst oxidizers provided in the respective branching supply passages, and
the individual oxidation units comprise:
a first individual oxidation unit including a first catalyst oxidizer to perform catalytic oxidation by using heat of a heat source gas from the heat source device, and a first heat exchanger to preheat a low-concentration methane gas that flows into an additional catalyst oxidizer provided in a branching supply passage on a downstream side, by using, as a heating medium, an oxidized gas discharged from the first catalyst oxidizer; and
at least one additional individual oxidation unit including an additional catalyst oxidizer to catalytically oxidize a low-concentration methane gas preheated by the first catalyst oxidizer or the additional catalyst oxidizer provided in a branching supply passage on an upstream side, and an additional heat exchanger which uses, as a heating medium, an oxidized gas discharged from the additional catalyst oxidizer.

2. The low-concentration methane gas oxidation system as claimed in claim 1, wherein each of the at least one additional individual oxidation unit includes an additional heat exchanger to preheat a low-concentration methane gas that flows into another additional catalyst oxidizer provided in a branching supply passage on a downstream side or into the first catalyst oxidizer, by using, as a heating medium, an oxidized gas discharged from the additional catalyst oxidizer in the additional individual oxidation unit.

3. The low-concentration methane gas oxidation system as claimed in claim 1, wherein each of the first individual oxidation unit and the at least one additional individual oxidation unit includes a bottom duct forming a passage for the oxidized gas from the catalyst oxidizer to the heat exchanger in each individual oxidation unit, the bottom duct having a side portion connected with the catalyst oxidizer and having an upper portion connected with the heat exchanger.

4. The low-concentration methane gas oxidation system as claimed in claim 3, wherein the heat exchanger in each individual oxidation unit includes a heating medium passage to allow the oxidized gas as a heating medium to pass therethrough in a direction vertically upward from the bottom duct.

5. The low-concentration methane gas oxidation system as claimed in claim 1, wherein the heat source device is a lean fuel intake gas turbine which operates using, as a fuel, a combustible component contained in the low-concentration methane gas.
